(19) United States
(12) Patent Application Publication
(10) Pub. No.: US 2024/0172742 A1
(43) Pub. Date: May 30, 2024

(54) TREE STAND INTEGRATING A BACKPACK FOR USE IN HUNTING, OBSERVATION AND THE LIKE

(71) Applicant: Kenneth E. Kirkland, Hueytown, AL (US)

(72) Inventor: Kenneth E. Kirkland, Hueytown, AL (US)

(21) Appl. No.: 18/383,021

(22) Filed: Oct. 23, 2023

Related U.S. Application Data
(60) Provisional application No. 63/428,144, filed on Nov. 28, 2022.

(51) Int. Cl. A01M 31/02

(52) U.S. Cl. CPC A01M 31/02

(57) ABSTRACT

A tree stand integrating a backpack for use in hunting, observation and the like including a frame having first posts. The first posts are positioned in parallel and include first horizontal posts and second horizontal posts at the top and bottom, respectively. The first posts include a U-shaped frame. The tree stand includes claw-like structures at the first horizontal posts and the second horizontal posts. The claw-like structures penetrate into the tree and provide required grip for the tree stand to rest against the tree. Further, the tree stand includes a rope for tying up the tree stand to the tree. The user connects the tree stand to the tree at an elevated position or on the ground. The user swings open the U-shaped frame to sit or stand and hunt, observe, etc. When not in use, the user carries the tree stand using straps similar to a backpack.

The present application claims the benefit of U.S. Provisional Application No. 63/428,144, filed Nov. 28, 2022; all of which is incorporated herein by reference in its entirety.

### FIELD OF THE INVENTION

The present invention generally relates to a tree stand. More particularly, the present invention relates to a tree stand integrating a backpack that secures to a tree at an elevated position or at a ground level to be used as a seat for use in hunting, observation, photography and the like, the tree stand is configured to be worn as a backpack when not in use.

### DESCRIPTION OF THE RELATED ART

It is known that hunters or photographers use tree stands for hunting animals or shooting images of the wildlife. A tree stand is a stand or platform that is open or enclosed and is secured to the tree. The tree stand secures to the tree at an elevated position and provides an ideal and safe observation point for inconspicuously observing and bagging/photographing of game/animals.

Several tree stands have been disclosed in the past. One such example is disclosed in U.S. Pat. No. 11,154,048, entitled “Tree stand platform assembly” (“the '048 patent”). The '048 patent discloses a tree stand platform assembly. The tree stand platform assembly includes a platform that has a perimeter edge with a front edge, a rear edge, a first lateral edge and a second lateral edge. The platform has a top surface, a bottom surface and an outer surface positioned between the top and bottom surfaces. The front edge is configured to engage a tree. A plurality of gripping protuberances is attached to and extends outwardly from the outer surface of the rear edge. The gripping protuberances are engageable by a user for stability when the user rotates relative to the platform.

Another example is disclosed in U.S. Pat. No. 10,524,467, entitled “Tree stand assemblies and methods of use” (“the '467 patent”). The '467 patent discloses tree stand assemblies and methods of use. The device includes a tree stand seat assembly having a seat portion and a back support portion; a foot stand assembly; a main brace member coupling the seat portion to the foot stand assembly; a first anchor extending from the main brace member; and a second anchor coupled with a linear track disposed on an underside of the foot stand assembly, the second anchor capable of translating along the linear track.

Yet another example is disclosed in a United States Publication No. 20140311828, entitled “Modular tree-mountable hunting stand” (“the '828 Publication”). The '828 Publication discloses a support frame rail with a central longitudinal axis is orthogonally coupled with a pivot beam. A support frame plate slidably couplable with the support frame rail includes an embedment projection. A hanger plate is fixable couplable with the support frame rail. A planar support platform is pivotably coupleable with the pivot beam. A saddle has a pommel portion, a saddle support portion, and a connecting straddle portion. A saddle bearing assembly defines a first rotation axis and is rotatably coupled with the saddle. A support frame bearing assembly defines a second rotation axis collinear with the central longitudinal axis. A pivot arm assembly is rigidly coupled with the saddle bearing assembly and the support frame bearing assembly. The straddle portion has a triangular cross-section, and enables adoption of an unsupported standing position, a partially supported standing position, or a weight-forward standing position, by a hunter straddling the straddle portion.

Although the above discussed tree stands are useful, they have few problems. For example, the tree stands discussed above are difficult to install and uninstall. Further, the tree stands are difficult to transport from one location to another when not in use.

Therefore, there is a need in the art to provide an improved tree stand integrating a backpack that secures to a tree at an elevated position or at a ground level to be used as a seat for use in hunting, observation, photography and the like, the tree stand is configured to be worn as a backpack when not in use.

### SUMMARY

It is one of the main objects of the present subject matter to provide a tree stand and that avoids the drawbacks of the prior art.

It is another object of the present subject matter to provide a tree stand that secures to a tree at an elevated position for use in hunting, observation, photography and the like.

It is another object of the present subject matter to provide a tree stand that can be used at a ground level by a user/hunter when the user is not at an elevated position from the above and wishes to be seated.

It is another object of the present subject matter to provide a tree stand that is easy to carry as a backpack by the user or hunter when not in use.

In order to overcome the limitations here stated, the present subject matter provides a tree stand for use in hunting, observation and the like. The tree stand includes a frame having first posts. The first posts indicate curved posts positioned vertically. The first posts are positioned in parallel and include first horizontal posts and second horizontal posts at the top and bottom, respectively. The first posts include a U-shaped frame or a platform. The U-shaped frame includes support bars. The U-shaped frame allows a user to sit or stand on it during its use.

The tree stand includes claw-like structures coupled to the first horizontal posts and the second horizontal posts. The claw-like structures penetrate into the tree and provide required grip for the tree stand to rest against the tree. Further, the tree stand includes a rope for tying up the tree stand to the tree. The user connects the tree stand to the tree at an elevated position or on the ground using the rope and the claw-like structures. The user swings open the U-shaped frame to sit or stand and hunt, observe, etc. When not in use, the user uninstalls the rope and the claw-like structures, and carries the tree stand over his/her shoulders using straps similar to a backpack.

The claw-like structures operate in a variety of positions. In one implementation, the claw-like structures position facing down when the tree stand is used as a backpack. Further, the claw-like structures position out when the tree stand is mounted to a tree. The like structures position outwards opposite side when the tree stand is mounted to the tree at the ground level.

In one advantageous feature of the present subject matter, the tree stand has curved first posts, and first horizontal posts and second horizontal posts that help to connect to the tree or tree trunk, whether substantially straight, curved, bent or otherwise shaped. Further, the curved first posts, and first horizontal posts and second horizontal posts allow the user to carry the tree stand on his/her back similar to a backpack. This helps the user to carry his/her hunting or observation equipment without any difficulty.

In another advantageous feature of the present subject matter, the tree stand is rotated or turned in order to utilize the claw-like structures and the rope to connect to the tree. When compared with the permanent and complex installation of the prior art tree stands, the presently disclosed tree stand is easy to install and uninstall without the need for additional tools. When the user sits on the tree stand or when the tree stand is carried by the user as the backpack, the claw-like structures are positioned facing downwards such that the claw-like structures do not cause injury to the user.

In another advantageous feature of the present subject matter, the claw-like structures penetrate into the tree and provide required grip for the user to stand or sit on the U-shaped frame during hunt and/or observation. Further, the claw-like structures swing sideways/upwards without obstructing the folding of the U-shaped frame when not in use allowing the user to carry the tree stand without any discomfort.

In yet another advantageous feature of the present subject matter, the U-shaped frame is folded, saving useful space when not in use. The user can utilise the U-shaped frame only when needed for seating or standing over it.

In yet another advantageous feature of the present subject matter, the tree stand can be made using lightweight materials. The tree stand provides easy installation and uninstallation as the user can adjust, position, manipulate, and/or the like with relative ease due to its lightweight construction.

Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

With the above and other related objects in view, the subject matter consists in the details of construction and combination of parts as will be more fully understood from the following description, when read in conjunction with the accompanying drawings in which:

FIG. 1 illustrates an environment in which a tree stand connects over a tree, in accordance with one embodiment of the present subject matter;

FIGS. 2A and 2B illustrate perspective views of the tree stand in a closed configuration, in accordance with one embodiment of the present subject matter;

FIG. 3 illustrates a perspective view of the tree stand in an open configuration, in accordance with one embodiment of the present subject matter;

FIG. 4 illustrates a perspective view of a claw-like structure, in accordance with one embodiment of the present subject matter;

FIGS. 5, 6 and 7 illustrate operational features of the claw-like structure, in accordance with one embodiment of the present subject matter;

FIGS. 8 and 9 illustrate the tree stand in use, in accordance with one embodiment of the present subject matter; and

FIG. 10 illustrates a user carrying the tree stand over his/her shoulder like a backpack, in accordance with another embodiment of the present subject matter.

### DESCRIPTION OF THE EMBODIMENTS OF THE INVENTION

The following detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed tree stand. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed tree stand.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter provides a description of a tree stand, it is to be further understood that numerous changes may arise in the details of the embodiments of the tree stand. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

The present subject matter discloses a tree stand for use in hunting, observation and the like. The tree stand includes a frame having first posts. The first posts are positioned in parallel and include first horizontal posts and second horizontal posts at the top and bottom, respectively. The first posts include a U-shaped frame or a platform. The U-shaped frame having support bars allows a user to sit or stand over it during use. The tree stand includes claw-like structures at the first horizontal posts and the second horizontal posts. The claw-like structures penetrate into the tree and provide required grip for the tree stand to rest against the tree. Further, the tree stand includes a rope for tying up the tree stand to the tree. The user connects the tree stand to the tree at an elevated position or on the ground. The user swings open the U-shaped frame to sit or stand and hunt, observe, etc. When not in use, the user carries the tree stand using straps similar to a backpack.

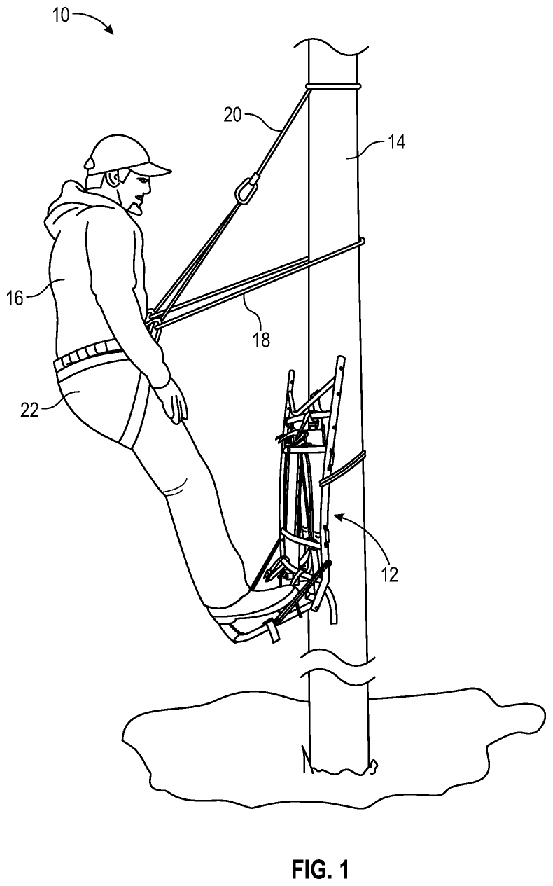

Various features and embodiments of a tree stand are explained in conjunction with the description of FIGS. 1-10.

Referring to FIG. 1, an environment 10 in which a tree stand 12 implements is shown, in accordance with one exemplary embodiment of the present subject matter. Tree stand 12 is also referred to as “Tree Saddle Hunting Platform”, “Tree Stand Platform”, “Hunting Stand”, “Platform”, “Saddle Platform”, “hunting device”, etc. Tree stand 12 removably connects to a tree 14 i.e., tree trunk and helps a user or hunter 16 to secure to tree 14. As can be seen from FIG. 1, user 16 uses a belt 18 and a tether 20 connecting saddle 22 to secure him/her at an elevated position. User 16 uses hunting equipment (not shown) such as a gun or a bow and arrow to shoot down a game/animal. Optionally, user 16 uses equipment such as a camera to take pictures of animals/birds and the like while being seated at ground level or standing on tree stand 12 at an elevated position from the ground.

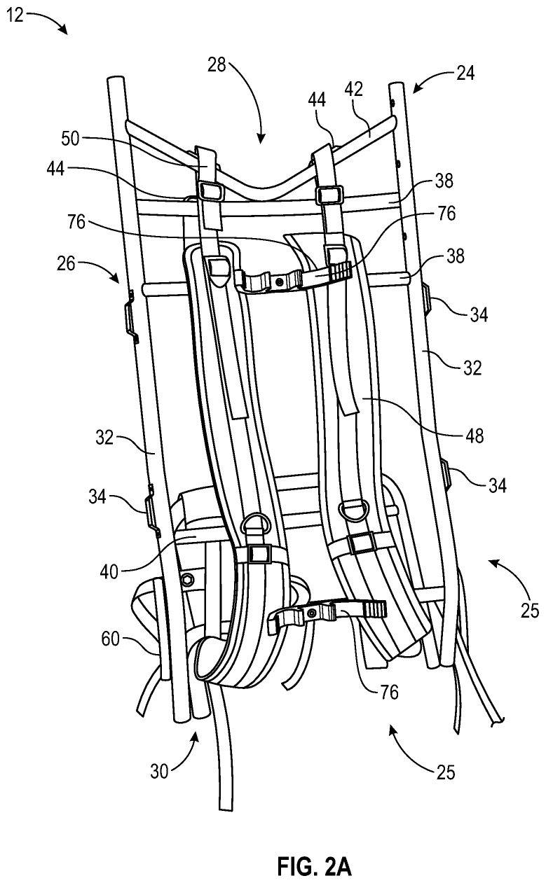

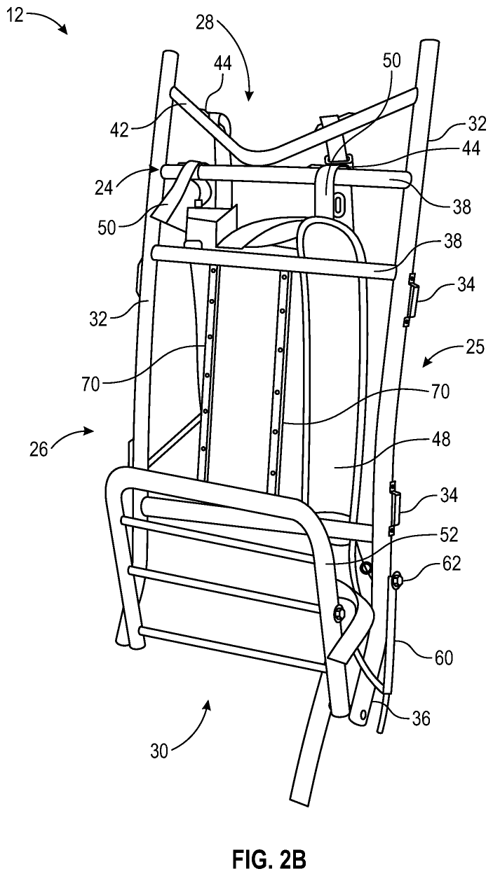

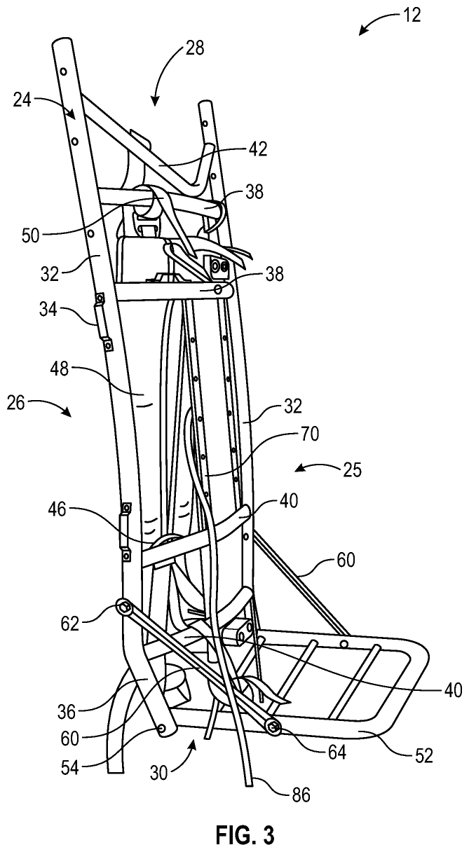

FIGS. 2A and 2B show a rear perspective view and a front perspective view, respectively of tree stand 12 in a folded/closed configuration, in accordance with one embodiment of the present subject matter. Further, FIG. 3 shows a perspective of tree stand 12 in an open configuration, in accordance with one embodiment of the present subject matter. Tree stand 12 includes a frame 24. Frame 24 is made up of metal, hard plastic or any other suitable material. Frame 24 includes a first end 25 and a second end 26. First end 25 indicates a front end of frame 24 and second end 26 indicates a rear end of frame 24. Further, frame 24 includes a top end 28 and a bottom end 30.

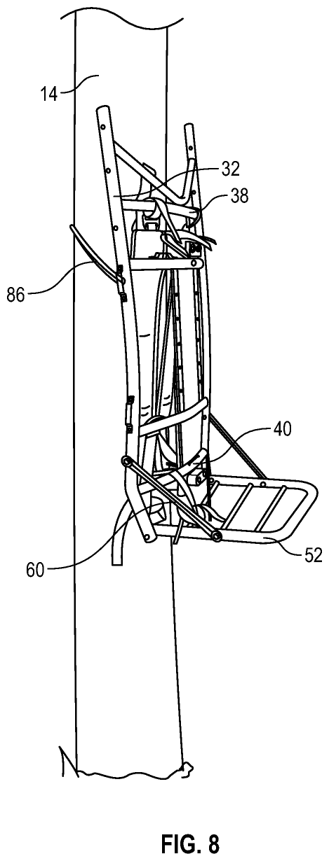

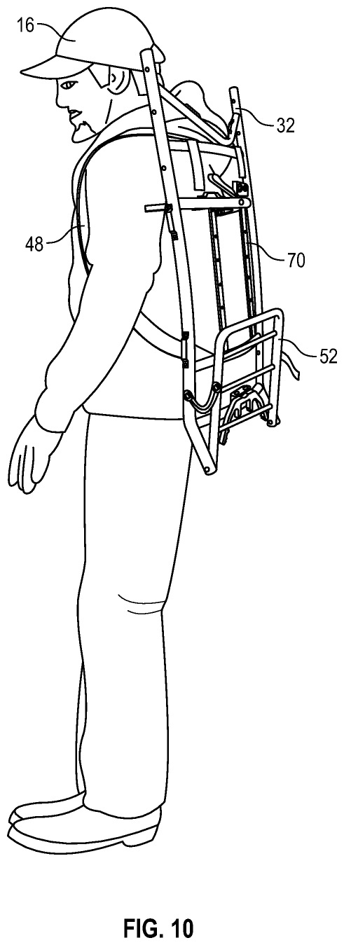

Frame 24 encompasses first poles or first posts 32. First posts 32 indicate vertical posts that are positioned in parallel to each other. First posts 32 include first loops 34 at the side. In one example, first loops 34 help to draw a rope 86 through and connect rope 86 to tree 14. First posts 32 are curved or angled, as shown in FIG. 3. The curvature ensures first posts 32 align with the shape of tree 14 (as shown in FIG. 8) and also allow user 16 to carry tree stand 12 on his/her back as a backpack when not in use (as shown in FIG. 10, for example). The curvature helps to use tree stand 12 as a saddle platform at the elevated position (stand configuration). Further, the curvature helps tree stand 12 to flip in order to fit back of user 16 for comfort and seat on (set configuration). Further, the curvature helps tree stand 12 to be a rigid frame for use as a backpack (carry configuration). It should be understood that the curvature ensures that user 16 is able to turn tree stand 12 and sit comfortably at the ground level. In other words, the curvature ensures first posts 32 fits user's back at the ground level. Each of first posts 32 has an extended portion 36. Extended portion 36 extends at an angle of approximately 45 degrees from the distal end of first post 32, as shown in FIG. 3. Extended portions 36 help a U-shaped frame 52 to swing upwards and downwards depending on the need, as shown in FIGS. 2B and 3, for example,

First posts 32 encompass first horizontal posts or poles 38 and second horizontal posts or poles 40. First horizontal posts 38 and second horizontal posts 40 indicate top horizontal posts and bottom horizontal posts, respectively that position in parallel to each other. In one example, first horizontal posts 38 and second horizontal posts 40 include two top horizontal posts and two bottom horizontal posts, respectively. However, one or more top horizontal posts and bottom horizontal posts may be added or removed depending on the need. First horizontal posts 38 and second horizontal posts 40 are curved or angled depending on the need. The curvature ensures first horizontal posts 38 and second horizontal posts 40 align with the shape of tree 14 (as shown in FIG. 8) and also allow user 16 to carry tree stand 12 on his/her back as a backpack when not in use (as shown in FIG. 10, for example).

First horizontal posts 32 include a V-shaped pole 42 at the top connecting first posts 32. Each of first posts 32 and V-shaped pole 42 include first loops 44. Further, second horizontal posts 40 include second loops 46. Frame 24 further includes shoulder straps 48. Shoulder straps 48 include connecting straps 50. Connecting straps 50 draw through first loops 44 and second loops 46 and help user 16 to carry tree stand 12 over his back. User 16 adjusts the length of connecting straps 50 and carries tree stand 12 over his/her back, as shown in FIG. 10.

Tree stand 12 includes a U-shaped frame 52 made up of metal, hard plastic or any suitable material. U-shaped frame 52 indicates a structure or platform that allows user 16 to sit or stand on it while user 16 is secured tree 14 with support from belt 18 and tether 20, as shown in FIG. 1, for example. U-shaped frame 52 hingedly connects to extended portion 36 using fasteners 54. U-shaped frame 52 includes support bars 56 extending horizontally. A person skilled in the art understands that it is possible to provide U-shaped frame 52 without support bars 56. Further, U-shaped frame 52 includes a connector or thread member 60 such as a rope, as shown in FIG. 3. Connector 60 provides support when U-shaped member 52 extends substantially at 90 degrees or more with respect to extended portions 36. In one example, connector 60 includes fasteners 62; 64 that help connector 60 to secure to first posts 32 and U-shaped member 52.

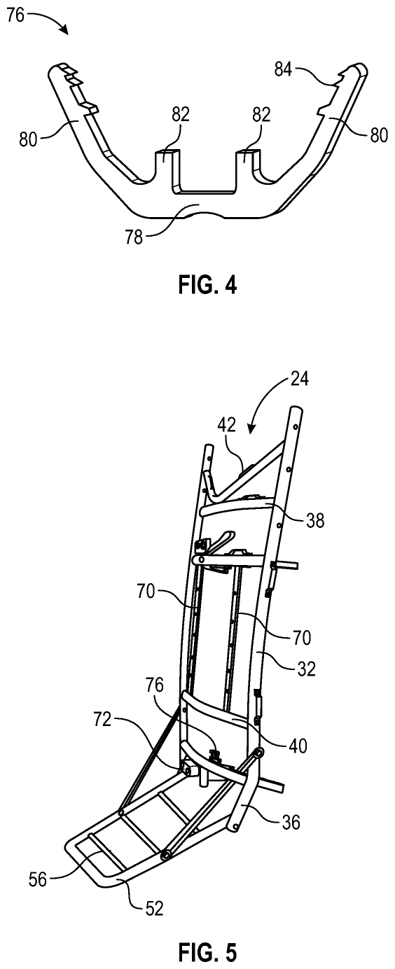

Further, tree stand 12 includes center rods 70 connecting first horizontal posts 38 and second horizontal posts 40. Center rods 70 provide support for first horizontal posts 38 and second horizontal posts 40. Further, tree stand 12 includes claw-like structures 76, each positioned at first horizontal posts 38 and second horizontal posts 40. Claw-like structure 76 is made of metal, hard plastic or any other suitable material. FIG. 4 shows a perspective view of claw-like structure 76, in accordance with one embodiment of the present subject matter. Claw-like structure 76 includes a straight section 78 and curved portions 80. Each curved portion 80 extends from a distal end of straight section 78. Further, claw-like structure 76 includes extending sections 82. Extending sections 82 extend parallelly from one another at the distal ends of straight section 78. In one implementation, curved portions 80 encompass teeth 84. Teeth 84 help to firmly grip tree stand 12 to tree 14 when tree stand 12 is connected to tree 14, as shown in FIG. 1, for example. Further, tree stand 12 includes a rope 86. Rope 86 helps to tie tree stand 12 to tree 14 at an elevated position from the ground.

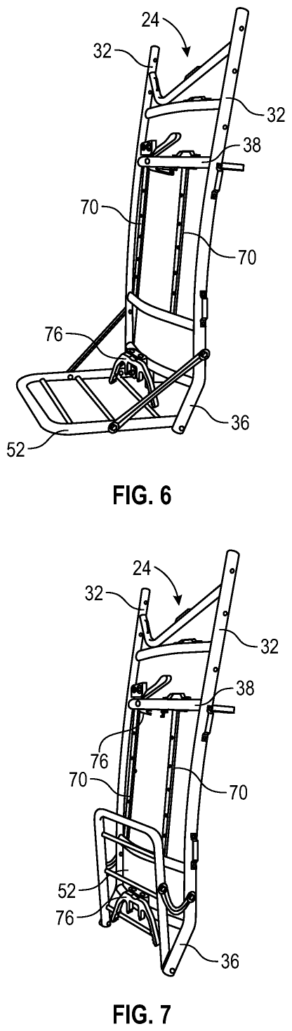

Referring to FIGS. 5, 6, and 7, positioning of claw-like structure 76 during folding and opening of U-shaped frame 52, is shown, in accordance with one embodiment of the present subject matter. FIG. 5 shows the feature of claw-like structure 76 facing second end 26 when U-shaped frame 52 is in open configuration. A person skilled in the art understands that when tree stand 12 is in use, claw-like structure 76 penetrates into tree 14 and helps to secure tree stand 12 to tree 14. When not in use, user 16 uninstalls fastener 72 and swings down claw-like structure 76, as shown in FIG. 6. Subsequently, user 16 lifts U-shaped frame 52 such that claw-like structure 76 draws through and positions facing down in between support bars 56 of U-shaped frame 52, as shown in FIG. 7. User 16 positions claw-like structure 76 in between support bars 56 facing down when not in use. This way, user 16 can carry tree stand 12 on his back without claw-like structure 76 causing discomfort for him/her (as shown in FIG. 10, for example).

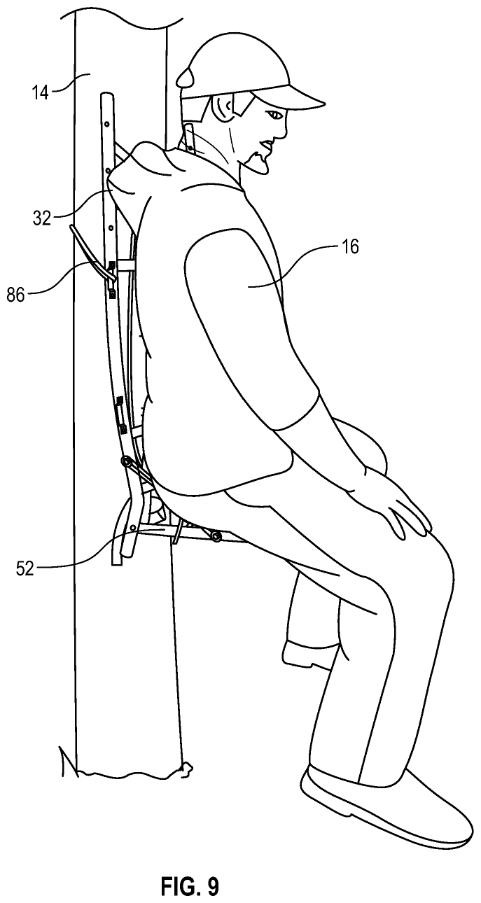

Now referring to FIGS. 8 and 9, the operation of tree stands 12 is explained, in accordance with one embodiment of the present subject matter. At first, user 16 aligns tree stand 12 such that first end 25 faces tree 14. Subsequently, user 16 rests tree stand 12 against tree 14 and draws rope 86 around tree 14 and ties it to first loops 34, as shown FIG. 8. As can be seen, the curved shape of first posts 32, and first horizontal posts 38 and second horizontal posts 40 ensures that tree stand 12 aligns with the shape of tree 14 without providing a gap in between tree stand 12 and tree 14. Further, user 16 pushes down tree stand 12 such that claw-like structures 76 provide sufficient grip to tree stand 12 against tree 12 with support from rope 86 connecting tree 14. Subsequently, user 16 swings open U-shaped frame 52 at 90 degrees or more, as shown in FIG. 8.

As specified above, user 16 positions tree stand 12 over tree 14 at an elevated position from the ground. Upon positioning tree stand 12, user 16 takes his/her position to hunt, observe and take images of animals, trees, birds and the like. In one exemplary implementation, user 16 hunts animals or shoots down birds while suspending from tree 14 using tree stand 12, as shown in FIG. 1. If need arises, user 16 sits over U-shaped frame 52 to take a break or rest, as shown in FIG. 9, for example. In one implementation, user 16 flips tree stand 12 while being connected to tree 14 in order to fit the curvature at the back of user 16. This provides comfort for user 16 and allows him to be seated on U-shaped frame 52, as shown in FIG. 9.

When not in use, user 16 uninstalls tree stand 12 from tree 14 and folds U-shaped frame 52. As specified above, user 16 draws and positions claw-like structure 76 facing down in between support bars 56 of U-shaped frame 52. Subsequently, user 16 carries tree stand 12 over his/her back with the help of shoulder straps 48, similar to a backpack, as shown in FIG. 10.

Based on the above, it is evident that the presently disclosed tree stand easily installs and uninstalls from the tree. The tree stand can be used in three configurations. First, the tree stand can be mounted to a tree at an elevated position from the ground and can be used as a saddle platform. Further, the tree stand can be flipped over to fit the back of user for the user to be seated at the ground level. Furthermore, the tree stand can be used as a back pack and can be easily carried over the user's shoulders. The tree stand has curved posts that help to connect to the tree of any size and shape, and allow the user to carry the tree stand over his/her back similar to a backpack when not in use. The tree stand includes claw-like structures that penetrate into the tree and provide required grip to the tree stand while withstanding the weight of the user and the hunting/observation equipment he/she is carrying.

A person skilled in the art appreciates that the tree stand may come in a variety of shapes and sizes depending on the need and comfort of the user. Further, many changes in the design and placement of components may take place without deviating from the scope of the presently disclosed tree stand.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

I claim:

1. I claim all of the above subject matter.
